(19) United States
(12) Patent Application Publication
(10) Pub. No.: US 2022/0133560 A1
(43) Pub. Date: May 5, 2022

(54) Pronator

(71) Applicant: John R. Breaux, Slidell, LA (US)

(72) Inventor: John R. Breaux, Slidell, LA (US)

(21) Appl. No.: 17/443,180

(22) Filed: Jul. 21, 2021

Related U.S. Application Data
(60) Provisional application No. 63/054,339, filed on Jul. 21, 2020.

(51) Int. Cl. A61G 7/00; A61G 7/05

(52) U.S. Cl. CPC A61G 7/001; A61G 7/0502

(57) ABSTRACT

This invention was developed in response to the need to move a patient from the supine (face up) position to the prone (face down) position and then back to the supine position after therapy is completed. There is the additional option to stop halfway in the lateral decubitus position for therapies which require the patient to be place on their side.

### PRIORITY CLAIM

This application claims the priority benefit of U.S. Provisional Application 63/054,339 filed Jul. 21, 2020.

### BACKGROUND OF THE INVENTION

There is a frequent need in the hospital setting to place a patient facedown (prone) on a bed or operating room table. This is a very labor-intensive process. The COVID-19 epidemic of 2020 has made this problem even more significant in that now a crew of five to seven healthcare providers need to dress out in full personal protective equipment and, with extreme caution, lift and turn a critically ill patient.

Furthermore, and ironically, the sickest patients are usually very obese. This can lead to injury to the patient or the healthcare provider. Over the past century, several devices and complex beds have sought patents for solutions to these problems. They suffer fates of failure due to their mechanical complexity or their extreme expense. Furthermore, with today's need to control infection risk, any device used to prone the patient must be easily sanitized.

Placing a patient who is experiencing extreme respiratory failure, whether from coronavirus or many other lung failure conditions, in the prone position has been shown to be truly lifesaving. However, this is not the only application for the pronator device. It can also be used to safely turn patients in the operating room who are to undergo spinal surgery, plastic reconstructive surgery, or thoracotomies. It can also be used in the care of stroke patients or spinal injury patients for hygiene or decubitus ulcer care. The pronator allows one nurse and respiratory therapist to pronate patients up to and above 400 pounds with minimal effort. The device is portable and adaptable to many forms of ICU beds and even field hospital cots. It is easily cleaned between patients and moved from room to room. It is assembled on one side of the patient's bed; the patient is turned, and the device is removed. Hours later, the device is assembled on the opposite side of the bed, the patient is turned back on their back, and the device is removed, cleaned, and stored away.

### BRIEF DESCRIPTION OF THE INVENTION

A pronator device to assist in turning a patient. The device has two frame members—a head frame member and a foot frame member. Both frame members are clampable to a hospital bed on the same side of the bed. Both frames extend above the bed mattress. A rotatable member with two ends is rotatably attached to the two frame members. A horizontal through slot extends substantially the length of the rotatable member. A wheel is attached to the rotatable member, and a ratchet apparatus controls the rotation of the rotatable member with a ratchet type action. The rotatable member is configured to accept a hospital sheet lengthwise through the slot. The hospital sheet that the patient lays on is inserted into the slot. The wheel is turned, gathering the sheet, and thereby rotating the patient.

### BRIEF DESCRIPTION OF THE DRAWINGS

FIG. 1 is a front perspective exploded view of the Head Fork frame member

FIG. 2 is a front perspective exploded view of the Foot Fork frame member

FIG. 3A is a front perspective view of the bracket.

FIG. 3B is a top perspective view of the bottom plate

FIG. 3C is a perspective vie of the tooth member.

FIG. 3D is a detailed exploded view of the ratchet assembly.

FIG. 4A is a perspective exploded view of the rotating member.

FIG. 4A-1 is a perspective view of the head end of the scroll.

FIG. 4A-2 is a perspective view of the foot end of the scroll.

FIG. 4B is a cross section through the scroll at the head puck.

FIG. 4C-1 is a perspective view of the head end of the scroll, exploded.

FIG. 4C-2 is a perspective view of the foot end of the scroll assembled.

FIG. 4D-1 is a side view of the foot shaft.

FIG. 4D-2 is a perspective view of the foot shaft.

FIG. 4D-3 is an end view of the head of the foot shaft.

FIG. 4D-4 is an end view of the tail of the foot shaft.

FIG. 5 is a perspective view of the wheel.

FIG. 6 is an illustration showing the assembled device on the right side of the medical bed and patient.

FIG. 7 is an illustration showing the relationship of a patient and sheet for use of the device

FIG. 8 is an illustration of the device on the Right side of the medical bed with the sheet between the two frame members.

FIG. 9 is an illustration with the assembly on the right side of the medical bed, and the sheet being fed through the center opening of the Scroll.

FIG. 10 is an illustration showing the sheet pulled tight through the Scroll to take up slack.

FIG. 11 is an illustration showing the Scroll being turned by the Wheel, pulling the sheet and the patient in an upward angle promoting the patient ‘roll’.

FIG. 12 is an illustration of the device having turned the patient about 45 degrees.

FIG. 13 is an illustration showing the device operating until the patient has ‘rolled’ to their side.

### DETAILED DESCRIPTION OF A PREFERRED EMBODIMENT

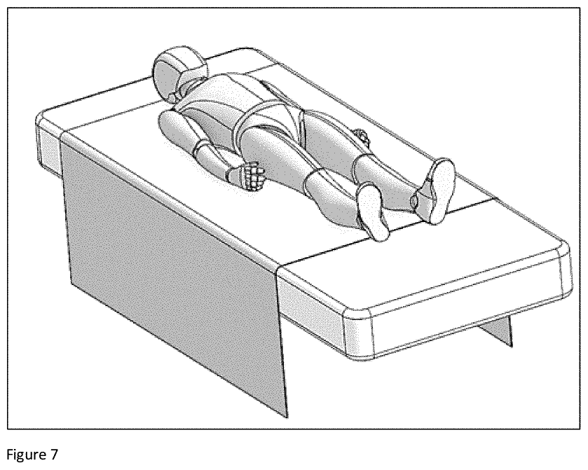

The assembled Pronator 1 (see FIG. 7) features four major parts: two frame members (a head fork frame member 100, a foot fork frame member 200), a rotatable member (a scroll 300), and a wheel 400.

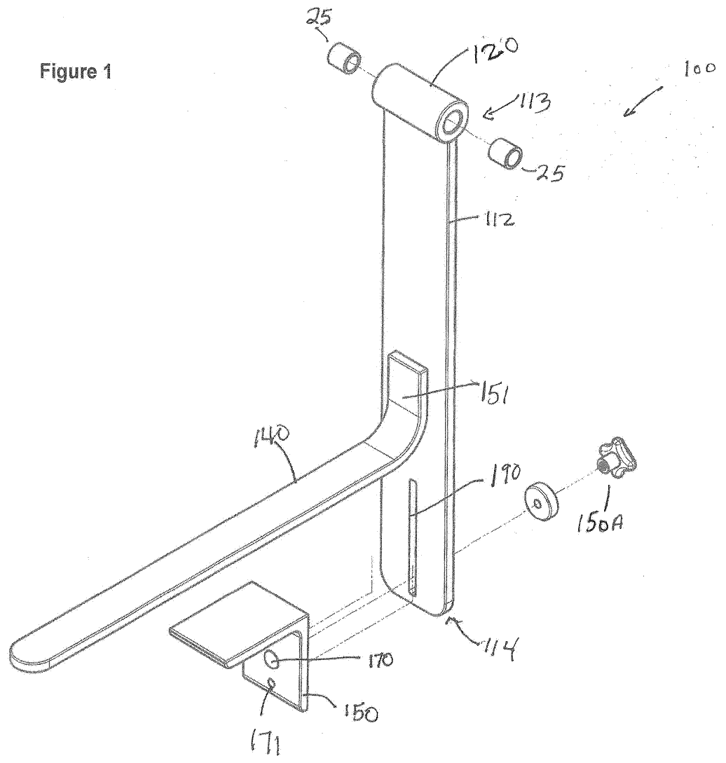

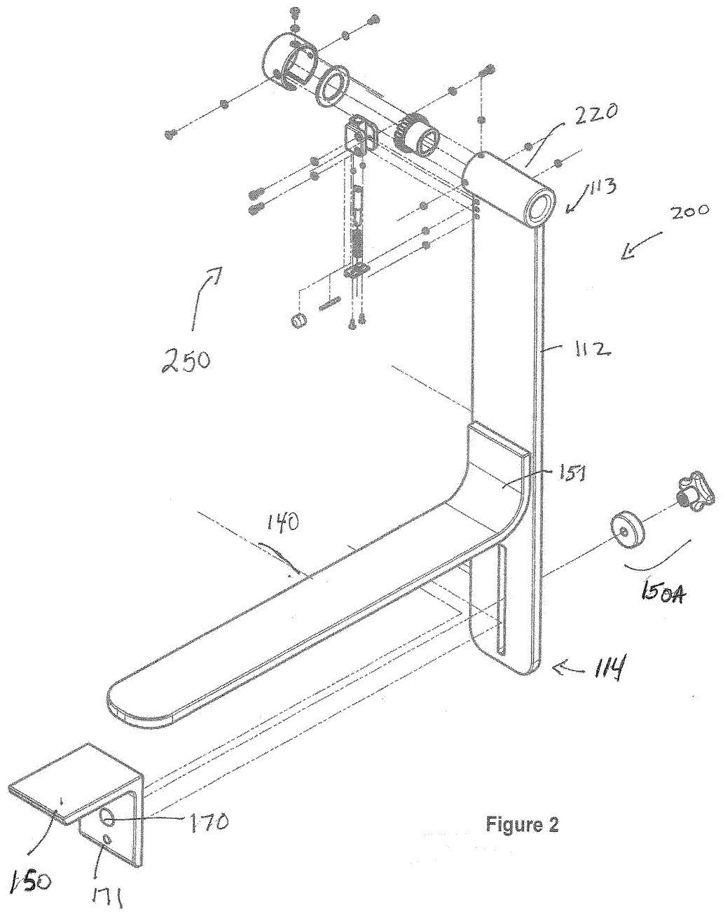

The two frame members, a head fork member 100 and a foot fork member 200, are structurally similar. As shown in FIG. 1 and FIG. 2, each fork member has an upstanding vertical member 112, which is preferably a flat plate member having a top end 113 and a bottom end 114. The two L-shaped forks extend outwardly at 90 degrees from the vertical member 112 near the bottom end 114 of the upstanding member 112. The upper fork 140 is longer than the bottom fork 150. The upper fork 140 is fixedly attached, such as by welding L fork flat 151 to the vertical member 112. The bottom fork 150 is adjustably attached to the vertical member 112 by a bolt 150A that extends through a hole 170 in the L end of the member. The vertical member 112 has a central vertical slot 190 near the bottom end 114, through which the bolt 150A extends through to be bolted to the vertical member 112 and fix the location of the bottom fork 150. There is a second opening 171 on the L of the bottom fork 150 below the bolt opening 170 through which a dowel can be inserted to pass through the vertical slot 190, to help keep the bottom fork 150 from rotating.

The vertical member's topmost end 113 terminates in a mounting member; here, a hollow head cylinder 120 on the head fork member 100, and a hollow foot cylinder 220 on the foot fork member 200. As shown in FIG. 1, the head hollow cylinder 120 has a bushing 25 pressed into each end of the hollow of the cylinder 120. When installed as later described, the cylinder will be about twenty inches above the base of a hospital bed mattress; that is, the frame members 100 and 200 have a top portion that extends above the mattress when installed.

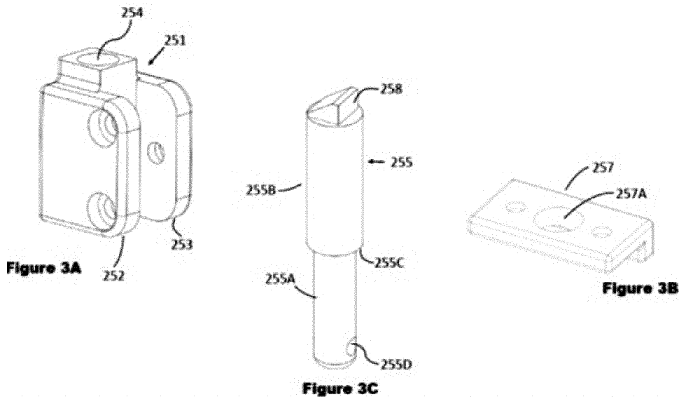

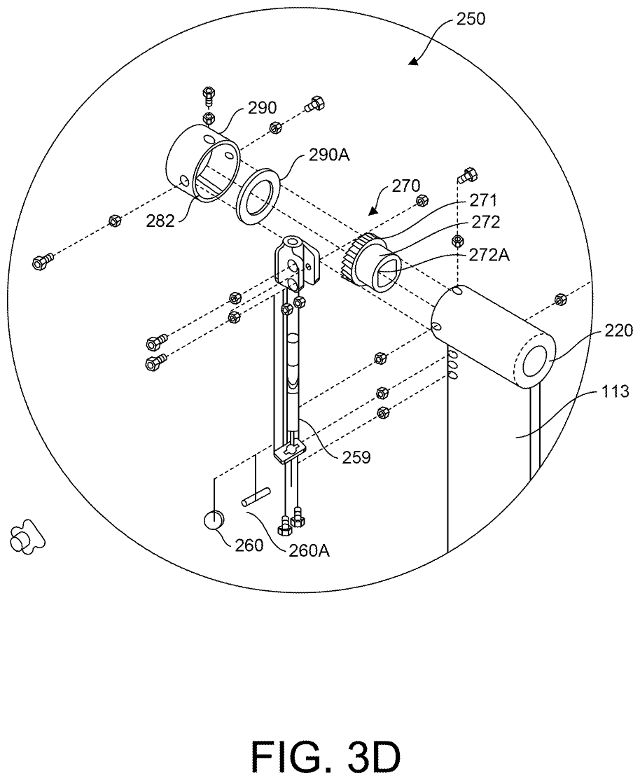

As shown in FIG. 2, the foot hollow cylinder 220 has part of a ratchet apparatus 250 coupled to one end of the hollow foot cylinder 220 and the upper end 113 of the foot vertical member 112. Best seen in the detail of FIG. 3A. The ratchet apparatus 250 includes a bracket 251 that is attached to the top end 113 of the foot vertical member 110 underneath the hollow head cylinder 220. The bracket 251 is bolt attached to the foot vertical member through holes on the foot vertical member 110. The holds include Heli-coils for bolting. In many instances, Heli-coils are inserted into in many openings of the Pronator 1 to accommodate a bolt. The bracket 251 includes two opposing plates 252 and 253 and an open cylinder 254 positioned therebetween, better seen in FIG. 3A. The open cylinder 254 houses a spring 259 loaded tooth member 255. A bottom plate 257 is bolted to the bottom end of bracket 251, which slips onto the vertical member 113, which is bolted to the vertical member. The bottom plate 257 has a center opening 257A for the bottom end 255A of the tooth member 255 to pass through. The bottom plate is shown in FIG. 3B, and the tooth member is shown in FIG. 3C. The tooth member 255 is generally cylindrical, with a bottom smaller cylinder portion 255A and a top portion 255B, with a ledge 255C therebetween. On the top of the tooth member is a tooth 258. The tooth member 255 is biased upwardly by the spring 259, which surrounds the bottom end 255A of the tooth member 255. The bottom side of the spring is supported on the bottom plate 257 and on the top side, support is from the ledge 255C, thereby biasing the tooth member 255 upwardly. Also shown in FIG. 3D is a knob 260 that is has a pin rod 260A attached at one end and the other end is inserted through a hole 255D in the tooth member's 255 bottom end 255A. The knob 260, by rotation in the horizontal plane, allows the orientation of tooth member 255 and tooth 258 to change.

The ratchet apparatus 250 includes a gear member 270 that has gear 271 with a center opening 271A (not shown). An inwardly directed hollow sleeve 272 is fixedly attached to the gear 271 and axially aligned with the gear 271. The hollow sleeve opening 272A is also shaped as that of the gear opening, and both shaped to receive a foot shaft 380, later described. As shown in FIG. 3D, the openings are square shaped.

The sleeve 272 extends into the interior of the foot cylinder 220, while the gear 271 is located exterior to the foot cylinder's 220 end. The gear member 270 is held in place with an end cap 290 covering the gear 271, with a bushing 290A between. The end cap 290 is attached to the end of the foot cylinder 220. The end cap 290 has a center opening 281 (not shown) on the cap end that is circular shaped to receive the foot shaft 380 and allow the foot shaft to turn in the opening, as later described. The end cap opening, 281, the gear opening 271A and the hollow of the sleeve 272A are aligned, and the openings are same size and shape (in the present embodiment, square). The endcap 280 also has a slit opening 282 on the bottom of the end cap 280 to allow the tooth 258 on the end of the tooth member 255 to pass through and interface with the gear 271. The tooth 258, interacting with the gear 271, acts with a ratchet type action. The orientation of the tooth can be changed with the knob 260 to alter the interaction.

The knob 260, when facing toward the patient, allows the gear 271 to rotate counterclockwise in steps, but not clockwise. The knob 260, when rotated in the horizontal plane 90 degrees, rotates the tooth member 255 to a neutral position where the tooth 258 is disengaged from the gear 271, allowing the gear 271 to rotate freely in either direction If the knob 260 is rotated 180 degrees, the tooth 258 interfaces the gear 271 and allows clockwise rotation, but not counterclockwise rotation.

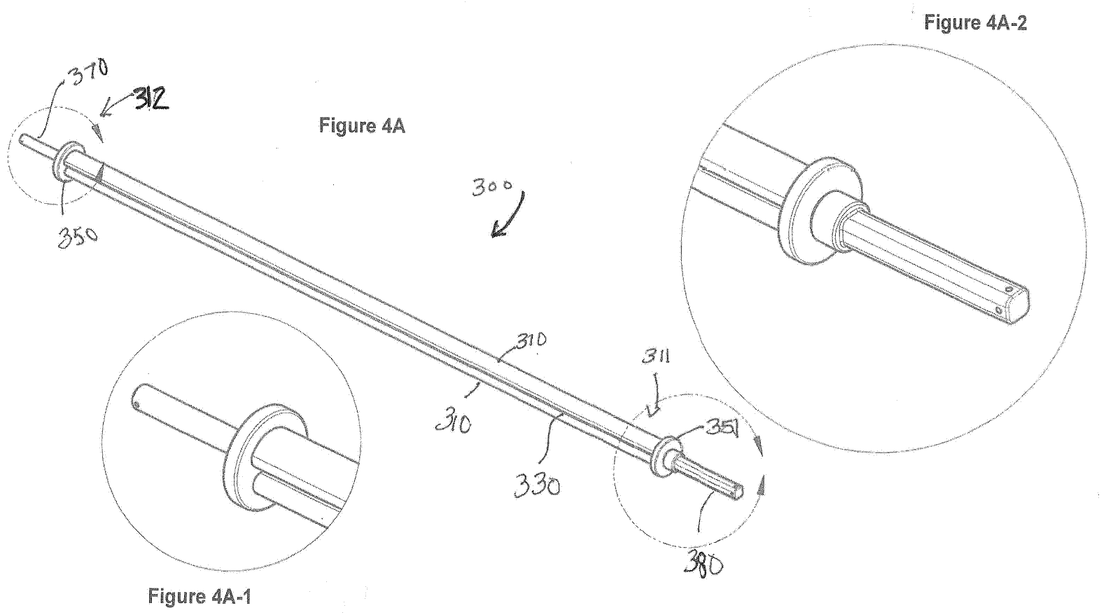

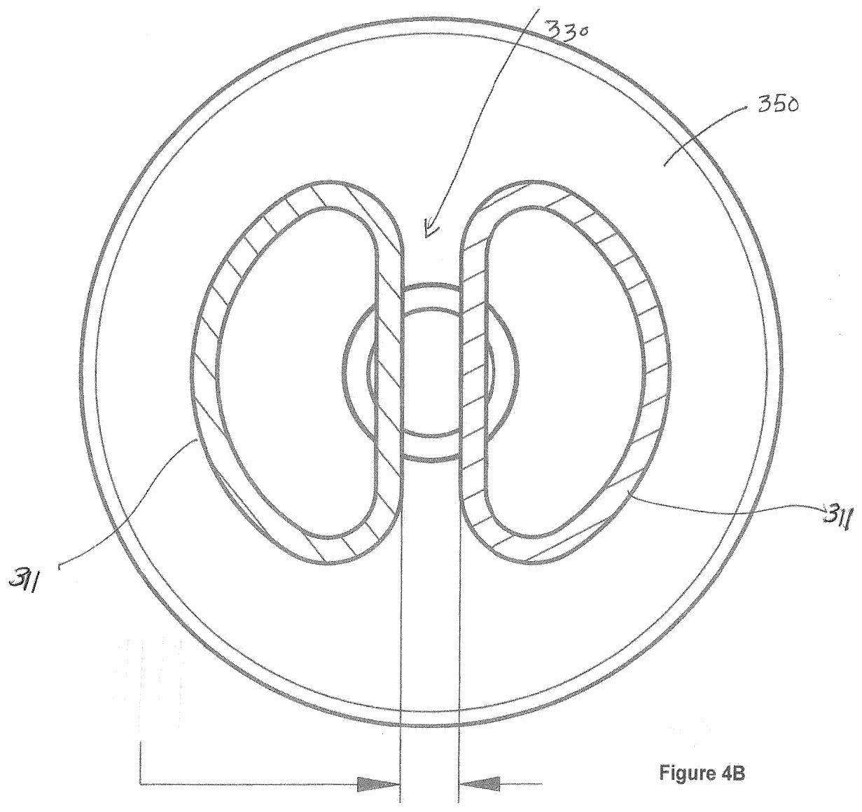

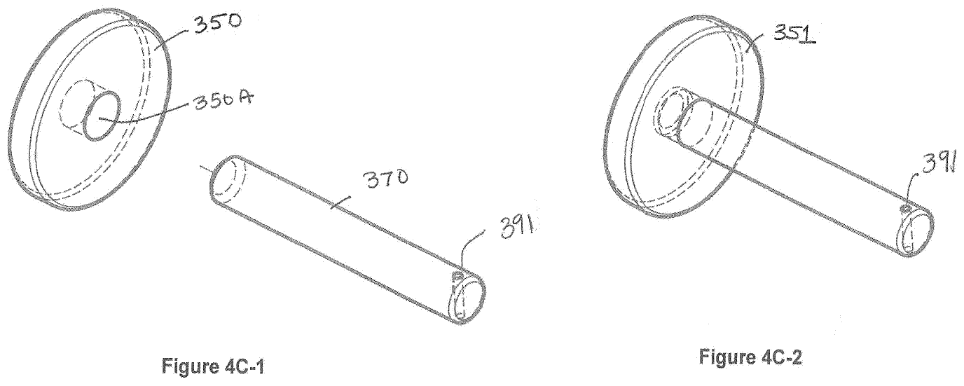

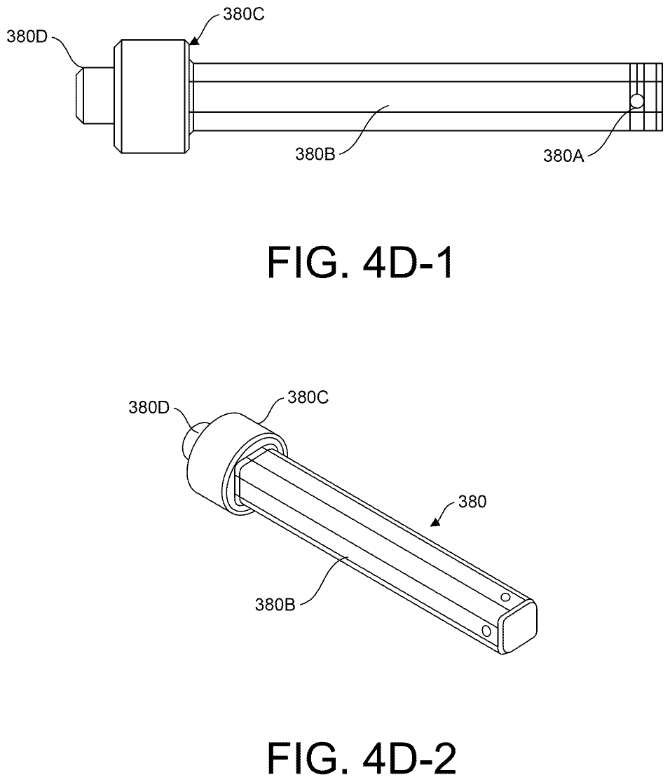

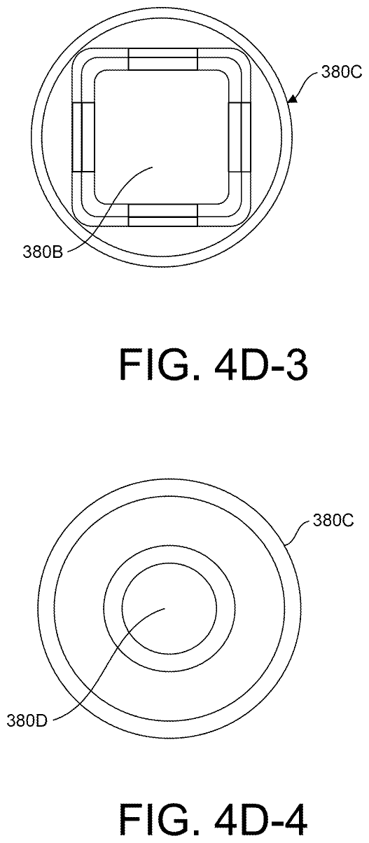

In the embodiment shown in FIG. 4A, the rotatable member, the scroll 300, includes two parallel but offset scroll members 310. The scroll members 310, in the present embodiment, are D shaped tubes with a foot end 311 and a head end 312. In the embodiment shown, the scroll members are about five feet long. Each end of the two scroll members are fixedly connected to end caps, a head end cap 350 and a foot end cap 351. In the embodiment shown, the end caps 351 and 350 are solid metal pucks, where the pucks are welded to the D shaped tubes 310 so that the two tubes 310 are parallel but offset, creating a slot or passageway 330 between the two tubes 310, which runs the length of the tubes 310, that is substantially the length of the scroll. The passageway 330 is thin, to allow a bedsheet to pass between the two tubes through the slot 330. The cross section through the scroll at the head endcap shown in FIG. 4B shows the relationships. The D shaped tubes are one embodiment, other shapes are feasible, including round, square, or two half cylinders (not preferred). The scroll, endcaps or pucks, and shafts all are part of the rotatable member, and all rotate in unison with the scroll.

Each puck end cap has a center-aligned hole through the puck to accept an outwardly extending shaft. The head end cap puck 350 has a round hole 350A into which a round cylindrical shaped head shaft 370 can be inserted into and fixed in, such as by welding. See FIGS. 4C-1 and 4C-2. The foot end cap puck 351 also has a round shaped center hole 351A (not shown), into which the foot shaft 380 is inserted and fixed, such as by welding. As seen in FIGS. 4D-1, 4D-4 terminating shaft of the foot shaft 380B is square shaped. The portion of the foot shaft adjacent the puck is a round collar, 380C (for proper placement on assembly). See FIGS. 4D-2, 4D-3. The portion of the foot shaft, 380D, to be inserted in the puck hole, is round. See FIG. 4D-4. The foot shaft 380 is generally formed as an integral member. Each shaft has an opening, 370A and 380A respectively, through the shaft at the end of the shaft distal from the end caps. The use of a center opening in the pucks ensures that the shafts will be axially aligned with the axis of rotation of the scroll. As later described, each shaft 370 and 380 is sized to extend through the associated top cylinders 120 and 220 on the frame members.

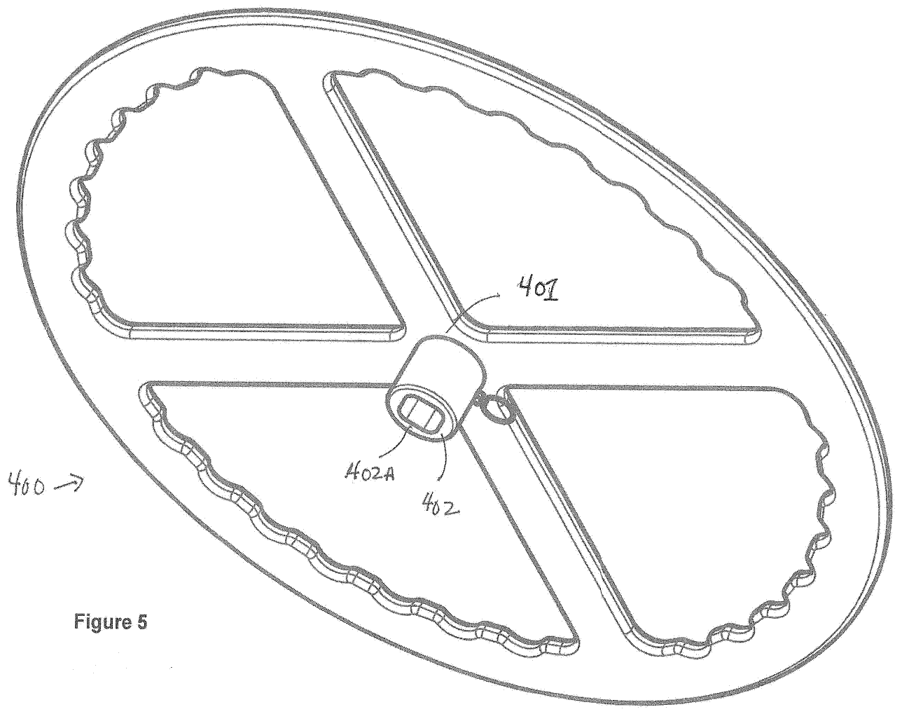

The Pronator 1 also includes a wheel 400, shown in FIG. 5, that can be affixed to the end of the foot shaft 380, for turning the scroll 300 and attached shafts 370 and 380. The wheel 400 includes a center axis 401 on which a shaped hub 402 is positioned; here, a hub 402 with a square shaped center opening 402A is shaped to receive the end of the square foot shaft 380. The hub 402 has an opening containing a ball detent pin 403 (not shown).

### Assembly

To assemble the Pronator 1 for use, the following steps can be used, although many methods can accomplish the assembly. Assemble the device on the side of the bed opposite of the direction the patient is to be turned.
1. Insert at the foot of the bed the long top fork 140 of the foot fork member 200, under the patient's mattress but above the bed frame. Insert it about halfway.
2. Insert the square foot shaft 380 on the scroll 300 into the open end 281 of the endcap 280 on the foot cylinder 220 on top of the foot fork member 200; insert until the parts are flush against each other. The foot shaft 380 will extend past the end of the foot cylinder 220.
3. Insert the top fork 140 of the head fork member 100 under the patient's mattress but above the bed frame. Be sure to only insert it halfway and use the location of the foot end of the scroll as a guide to the insertion location.
4. Insert the end of the head shaft 370 on the scroll into head cylinder 120 on the top of the head fork member 100; insert until the parts are flush against each other. The shaft 380 will protrude from the cylinder 120. Make sure the scroll 300 stays installed on the foot fork member 200.
5. Advance both forks under the mattress until both vertical members 110 are pressed flush to the patient's mattress.
6. Insert a safety rod into the opening 380A at the end of the head shaft 380 to secure the scroll from disconnecting from the head frame member 100.
7. Install the wheel 400 on the end of square foot shaft 380 protruding from the foot cylinder 220. Assemble to the ball dent pin 403 is on the side of the hub that aligns with the foot shaft 380 with the end opening 380A. Pull out the ball dent pin 403 on the wheel hub 402 to allow the wheel 400 to slide into place on the foot shaft 380. The ball dent pin will click back into place into the opening 380A on the foot haft 380.
8. Secure the bottom forks 150 of each fork member 100, 200 to the underside of the bed frame, clamping tightly to the underside of the bed frame. If the bed frame width exceeds standard clamp opening length, then the clamps can be turned 180 degrees to allow up to 10 extra inches of opening.

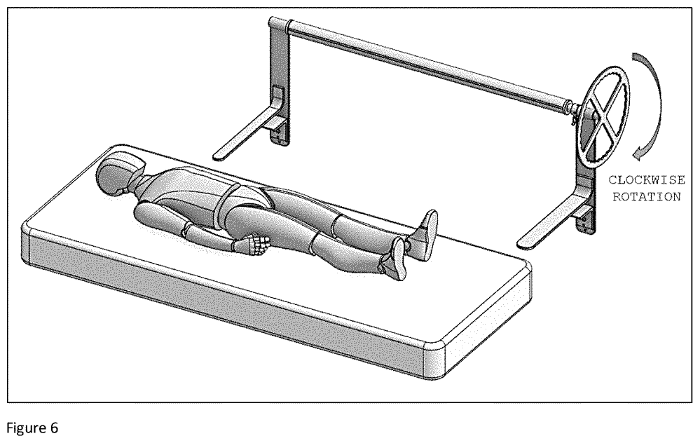

The assembled device 1, not installed on a bed, is shown in FIG. 6.

### Operation and Use

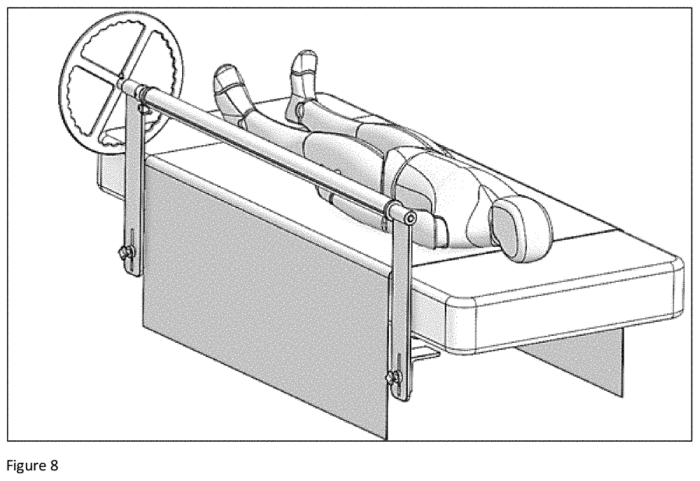

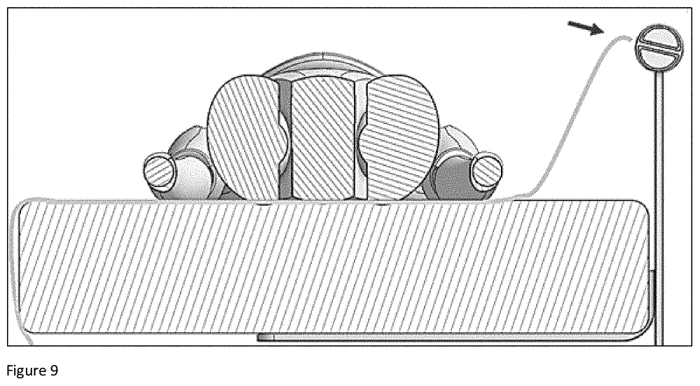

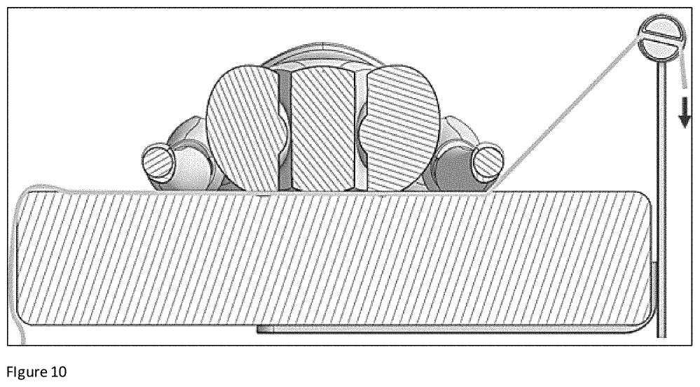

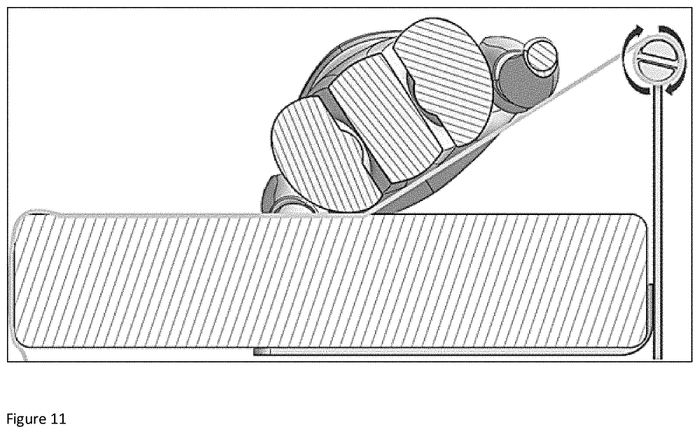

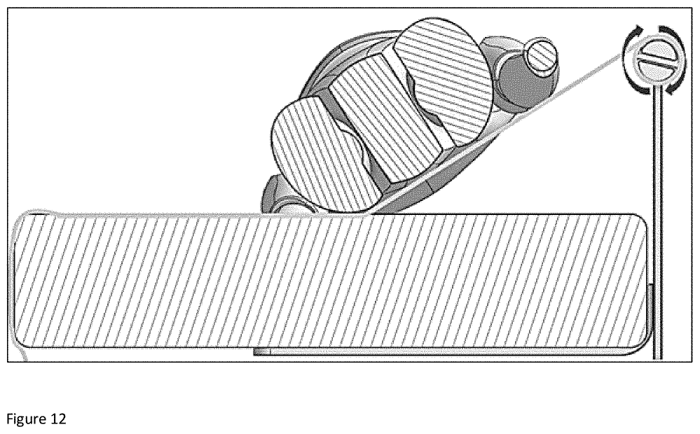

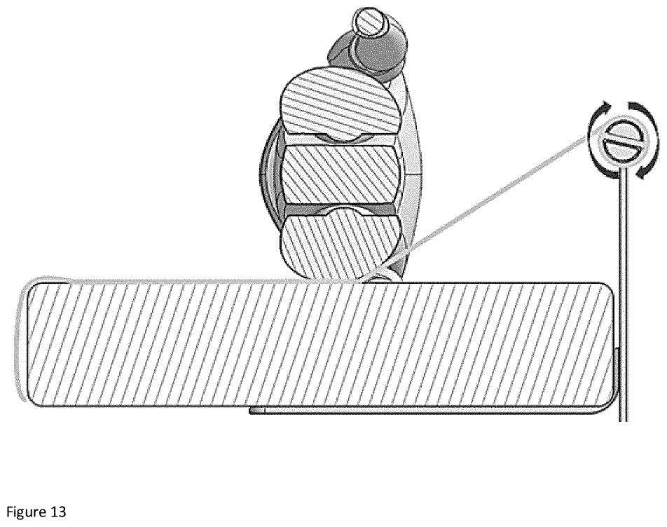

To use the assembled pronator, the following steps are followed:
1. Ensure that the patient has been placed on a standard bedsheet that has been oriented sideways with one third of the sheet length on the opposite side that the patient is being turned to. See FIGS. 7 and 8.
2. Insert the sheet on the side that the patient will be turning away from into the slot on scroll. See FIG. 9.
3. Pull the sheet downward through the slot till it is taught. See FIG. 10.
4. Turn the knob 260 on the ratchet assembly 250 so that it is turned toward the patient.
5. A monitoring staff member(s) should be standing adjacent to the bed or operating room table to ensure that a patient does not roll off the table.
6. Ensure the patient's arms are tightly tucked by their sides. See FIG. 8.
7. If the Pronator is assembled on the patient's right side, the wheel is turned counterclockwise.
8. Rotate the wheel 400 to turn the patient. See FIG. 11.
9. The patient's body will be lifted and rotated on their central axis and the patient should remain centered on the bed. Once the patient is rotated 90 degrees (FIG. 13), they should be rotated the remaining 90 degrees by the assistants. For instance, the ends of the sheets away from the pronator can be grabbed and wrapped against the patient. With the ends held, further rotation of the wheel will lower the patent to the table, in a flipped orientation.
10. Once the patient is rotated completely and secure, apply a little tension on the wheel, turn the knob 260 of the ratchet mechanism 250 in the neutral position (turned 90 degrees). The scroll 300 can then be slowly unwound to release the sheet.
11. The patient's arm and head are placed in your institution's approved positions.
12. The previous short end of the bedsheet should now be the long end and the previous long end of the sheet is now the short end. This will be available for turning the patient back to their former position after the treatment time has ended.

The device is manufactured mostly of metal; aluminum, where possible, and stainless steel. The device breaks down into parts that are easy to transport and fairly lightweight. The device can be manufactured in various ways; with ratchet assembly on the head fork, for instance. Both shafts can be the same shape, such as square, but the two different shaped shafts assist in error-free assembly.

1. A pronator device comprising a head frame member and a foot frame member, both frame members couplable to a hospital bed frame and mattress and configured so that when attached, both frame members have a portion extending above the mattress; a rotatable member having a head end and a foot end, that are rotatably attachable to the head frame member and foot frame member respectively, a portion of each frame member extending above the bed mattress when installed on a hospital bed and mattress; a horizontal slot extending substantially through length of the rotatable member and configured to accept a hospital sheet lengthwise through the slot; a wheel connectable to the rotatable member to turn the rotatable member; and a ratchet apparatus interfacing the rotatable member to control the rotation of the rotatable member.

2. The pronator device of claim 1 where the head and foot frame members each include a vertical member having a top end and a bottom end, and a top and a bottom “L” shaped fork member each extending at a right angle from the vertical member and attached to the vertical member near the bottom end, the top fork being fixedly attached and the bottom fork being adjustably attached to the vertical member.

3. The pronator device of claim 2 further comprising a head mounting member attached at the top end of the head vertical member and configured to rotatably mount to the head end of the rotatable member, and a foot mounting member attached at the top end of the foot vertical member and configured to rotatably mount to the foot end of the rotatable member.

4. The pronator device of claim 3, wherein the ratchet apparatus comprises a gear mounted on the foot end of the rotatable member, and tooth member moveably mounted near the top end of the foot vertical member, the tooth member configured to interact with the gear in a ratchet action.

5. The pronator device of claim 1 where the rotatable member comprises two scroll members mounted between a foot end cap and a head end cap, the two scroll members mounted to be parallel but offset, forming the horizontal slot between the two scroll members.

6. The pronator device of claim 5 wherein each scroll member is a “D” shaped tube.

7. The pronator device of claim 5 further comprising a head shaft attached to the head end cap and a foot shaft attached to the foot end cap, the two shafts being axially aligned with an axis rotation of the rotatable member, the head shaft configured to rotatably mount on the head mounting member and the foot shaft configured to rotatably mount on the foot mounting member.

8. The pronator device of claim 7 wherein one of the head or the foot shafts are square shaped.

9. The pronator device of claim 7 where the head shaft and the foot shaft are each configured to extend through their respective mounting members when mounted thereon.

10. The pronator device of claim 7 where both the head mounting member and foot mounting member comprise hollow cylinders.

11. A method of using a pronator on a patient positioned on a bed and mattress and laying on a bed sheet, the pronator comprising a head frame member attached to the bead and mattress near the head of the patient, a foot frame member attached to the bed frame and mattress near the feet of the patient. Both frame members are attached on the same side of the bed, both frame members having a top portion extending above the top of the mattress at the same height, and the top of the head frame member terminating in a head mounting member, and the top of the foot frame member terminating in a foot mounting member, and a rotatable member extending between and rotatably mounted on the head mounting member and the foot mounting member, a horizontal through slot extending substantially the length of the rotatable member, and configured to accept a hospital sheet lengthwise through the slot, a wheel connectable to the rotatable member to turn the rotatable member, a ratchet apparatus interfacing the rotatable member to control the rotation of the rotatable member, and a wheel attached to the rotatable member; the method comprising the steps of:
a) Place the patient on a standard bedsheet that has been oriented sideways with about one third of the sheet length on the opposite side that the patient is being turned to;
b) Insert the edge of the sheet on the side that the patient will be turning away from into the slot on the rotatable member;
c) Pull the sheet downward through the slot until it is taut;
d) Set the ratchet assembly so that the rotatable member can rotate away from the patient;
e) Ensure the patient's arms are tightly tucked by their sides;
f) Turn the wheel drawing the sheet therethrough and rotating the patient;
g) When the patient is rotated about 90 degrees, assistants will lower the patient the remaining 90 degrees;
h) Once the patient is rotated completely and secure, apply a little tension on the wheel, set the ratchet assembly for free rotation, and rotate the rotatable member toward the patient to release the sheet.
